(19) United States
(12) Patent Application Publication
(10) Pub. No.: US 2016/0016798 A1
(43) Pub. Date: Jan. 21, 2016

(54) A method for purification of circulating leaching solutions from phosphates and fluorides

(71) Applicant: OPENED JOINT STOCK COMPANY "UNITED CHEMICAL COMPANY URALCHEM'', Moscow (RU)

(72) Inventors: Mikhail Vladimirovich Genkin, Moscow (RU); Aleksey Vladimirovich Evtushenko, Moscow (RU); Aleksey Aleksandrovich Komkov, Moscow (RU); Alfiya Minerovna Safiulina, Moscow (RU); Vasiliy Sergeevich Spiridonov, Moscow (RU); Sergey Vladimirovich Shvetsov, Nizhegorodskaya oblast (RU)

(73) Assignee: OPENED JOINT STOCK COMPANY "UNITED CHEMICAL COMPANY URALCHEM", Moscow (RU)

(21) Appl. No.: 14/773,749

(22) PCT Filed: Nov. 8, 2013
(86) PCT No.: PCT/RU2013/000989

§ 371 Date: Sep. 8, 2015

(30) Foreign Application Priority Data
Mar. 5, 2013 (RU) 2013109741

(51) Int. Cl. C01B 21/46; C01B 7/07

(52) U.S. Cl. CPC C01B 21/46; C01B 7/0737

(57) ABSTRACT

The present invention relates to a method for purification of acidic solutions of salts, in particularly those formed in the course of complex apatite processing yielding rare-earth metal (REM) concentrate from phosphorus, fluorine and alkali metals impurities comprising precipitation of phosphorus and fluorine in the form of calcium phosphates and fluorides and alkali metals in the form of silicofluorides of alkali metals. In some embodiments before the precipitation of calcium phosphates and fluorides and silicofluorides of alkali metals, acid is selectively extracted into an organic extractant, and after the precipitation of calcium phosphates and fluorides and silicofluorides of alkali metals the acid is may be re-extracted from the extractant into an aqueous solution. Methods allow for the removal of phosphorus, fluorine and alkali metals impurities and regeneration of the acid.

### CROSS REFERENCE TO RELATED APPLICATIONS

This patent application is a national phase filing under section 371 of PCT/RU2013/000989, filed Nov. 8, 2013, which claims the priority of Russian patent application 2013109741, filed Mar. 5, 2013, each of which is incorporated herein by reference in its entirety.

### FIELD OF THE INVENTION

The present invention relates to technologies for recovery of valuable components from mineral raw materials and, in particular, to purification from phosphates and fluorides circulating leaching solutions used in the course of rare-earth metals (REM) recovery from phosphogypsum.

### BACKGROUND OF THE INVENTION

Various methods may be used to process raw materials with acidic solution. After removal of the target component from this solution, a large volume of liquid comprising acid and soluble salt remains. Use of these solutions is often complicated by the presence of impurities that impede the leaching of the target component. Removal of these impurities, as well as utilization of the solution is a complicated and expensive task.

It is known that among all types of phosphate raw materials processed for fertilizer, apatite concentrate, containing about 0.9% rare earth elements, is of the greatest practical value as a source of rare earth elements. Apatite has an advantage over other types of materials, such as loparite, in view of the composition and content of rare metals, of yttrium, medium and heavy rare earth elements.

In the course of processing apatite with nitric acid, REM contained in apatite transfers to a nitrogen-phosphate (nitrate-phosphate) solution. Complex salt composition of the resulting nitrogen-phosphate solution causes difficulties in extracting rare earth metals during the processing of apatite.

The main process for apatite treatment is sulphuric acid technology for producing phosphoric acid from apatite. In this case, the main waste product is phosphogypsum (calcium sulfate contaminated with impurities of P₂O₅, F, Fe, Al, Sr, REM), which comprises most of the rare-earth metals contained in apatite. Every year millions of tons of phosphogypsum containing about 0.5% REM in terms of oxides, which currently are not extracted from it, are sent to dumps. Furthermore, the presence of such dumps containing toxic compounds including fluorine is an environmental problem.

A process for recovering rare earth elements from solutions containing REM phosphates, calcium and mineral acid described in RU patent No. 2118613 comprises neutralizing the alkaline solution and obtaining the precipitate of REM phosphates.

In a method for extracting REM from apatite described in RU patent No. 2049727, nitrogen-phosphate solution obtained after processing apatite with acid and separating the precipitate is neutralized with ammonia, and the precipitate of commercial REM concentrate is separated from the solution.

It is well-known that phosphorus can be precipitated as calcium phosphate, while fluorine, sodium and potassium can be precipitated as calcium fluoride and sodium and potassium silicofluorides. Precipitation of these compounds, however, may occur only from neutral or slightly acidic (pH>3) solutions. When solutions containing 0.5 mol/L of acid are used, such methods become disadvantageous, since it results in significant consumption of reagents and deterioration of process economics.

A method for isolation of rare earth elements from nitric-phosphate solution comprising crystallization of calcium nitrate tetrahydrate from solution obtained after decomposition of apatite with nitric acid, precipitation and separation of sodium silicofluoride, neutralization of nitric-phosphoric acid solution with ammonia, separation of precipitate of REM phosphates from the mother liquor and washing the precipitate with water is described in Complex processing of phosphate raw materials with nitric acid. Ed. Goldinov A. L., Kopylev B. A. L.: “Chemistry” (rus), 1982, pp. 154-156. Neutralization of nitric-phosphoric acid solution with gaseous ammonia or ammonia water is carried out in two stages: at the first stage the solution is neutralized to a value at which precipitate is not formed, pH 0-0.1, at the second stage the solution is neutralized to a final pH 1.1-1.4 at a temperature of 80° C.

Disadvantages of these methods are that the acids used to recover REM is neutralized and removed from the process with the formation of large volumes of dilute solutions, which leads to a substantial increase in energy costs and complexity of the process. In addition, the resulting REM concentrate is contaminated with impurities.

### SUMMARY

Embodiments of the present disclosure provide for methods of purification of acidic solutions of salts from phosphorus, fluorine and alkali metals impurities. Methods may comprise precipitation of calcium phosphates and fluorides and silicofluorides of alkali metals. Before the precipitation of calcium phosphates and fluorides and silicofluorides of alkali metals, acid may be selectively extracted into an organic extractant, while phosphorus, fluorine and alkali metals remain in raffinate. After the precipitation of calcium phosphates and fluorides and silicofluorides of alkali metals the acid may be re-extracted from the extractant into an aqueous solution.

In some embodiments, the alkali metal may be selected from a group comprising sodium and potassium. In some embodiments, the acid may be selected from a group comprising nitric acid, hydrochloric acid, hydrobromic acid, hydroiodic acid, and perchloric acid. In some embodiments, after the acid extraction and before the precipitation of calcium phosphates and fluorides and silicofluorides of alkali metals from aqueous solution, other valuable components presented in the aqueous solution other than phosphorus and fluorine may be recovered therefrom. The other valuable components may be rare-earth metals. In some embodiments, the recovery of valuable components except phosphorus and fluorine from the solution may be performed before the acid extraction. In some embodiments, the recovery of other valuable components except phosphorus and fluorine from the solution may be performed simultaneously with the acid extraction using an extractant capable of recovering the acid and the other valuable components simultaneously. In some embodiments, the recovery of valuable components except phosphorus and fluorine may be performed during the intermediate stage of the acid extraction by directing the acidic solution of salts to the acid extraction, withdrawing the aqueous solution containing the valuable component to the extraction of valuable components, and returning the resulted aqueous solution to the acid extraction process. In some embodiments, ketones, mono- and polyethers, esters and amides of phosphoric acid or mixtures thereof are used for extraction of nitric, hydrochloric acids, hydrobromic and hydroiodic acids, and esters of phosphoric acid may be used for extraction of perchloric acid.

### BRIEF DESCRIPTION OF THE FIGURES

FIG. 1 depicts a flowchart for recovery of a valuable component from salt solution, where an acid is extracted after recovery of the valuable component from an aqueous solution into organic phase.

FIG. 2 depicts a flowchart for recovery of a valuable component from a salt solution, where an acid is extracted before recovery of the valuable component from an aqueous solution into organic phase.

FIG. 3 depicts a flowchart for recovery of a valuable component from a salt solution, where an acid is extracted from an aqueous solution into organic phase simultaneously with the valuable component.

FIG. 4 depicts a scheme for recovery of a valuable component from a salt solution, where recovery of the valuable component is carried out between stages of the acid extraction.

### DETAILED DISCLOSURE

One aspect of the present invention provides a method for purification of acidic solutions of salts from impurities of phosphates, fluorine and alkali metals, and the use of this method simultaneously avoids a loss of acid.

In the present invention, the term “REM” is used to indicate lanthanides and yttrium. Also, the symbol “Ln” is used for these elements.

Embodiments of the present disclosure may advantageously address aforementioned problems by liquid extraction of acid into organic extractant. The organic extractant is selected so that impurities of phosphorus, fluorine and alkali metals remain in the aqueous solution. Then, calcium compounds are added to obtained subacid raffinate, and the raffinate is neutralized to pH>6. The addition of calcium in the form of chalk (CaCO₃) or lime (CaO or Ca(OH)₂) is preferable, thus combining calcium entry into the solution and its neutralization. The phosphate and fluoride ions are precipitated in the form of CaHPO₄, Ca₃(PO₄)₂, CaF₂. If silicofluoride anions are present in the solution, these anions are precipitated in the form of (Na,K)₂SiF₆ by adding sodium or potassium compounds. If purification of the solution from sodium and potassium is required, fluosilicic acid or calcium silicofluoride is added to the raffinate, thus precipitating Na₂SiF₆ and K₂SiF₆. The purified neutral solution is routed to the re-extraction of acid from the organic phase, so the organic extractant, circulating aqueous solution and acid are regenerated. Since the process of extraction and re-extraction is reversible, it is possible to select conditions in such a way that the loss of acid will be reduced by 75-98%. For this purpose it is preferable to carry out acid extraction and re-extraction stages in multistage countercurrent cascades. It is also necessary to select suitable organic extractant, flow ratio of organic extractant and an aqueous solution, and the number of stages of extraction and re-extraction.

For the extraction of nitric and hydrochloric acids (as well as hydrobromic and hydroiodic acids), ketones, mono- and polyethers, esters and amides of phosphoric acid or mixtures thereof may be used. For the extraction of perchloric acid, esters of phosphoric acid are preferably used. All these compounds poorly extract phosphoric acid and fluoride and silicofluoride anions.

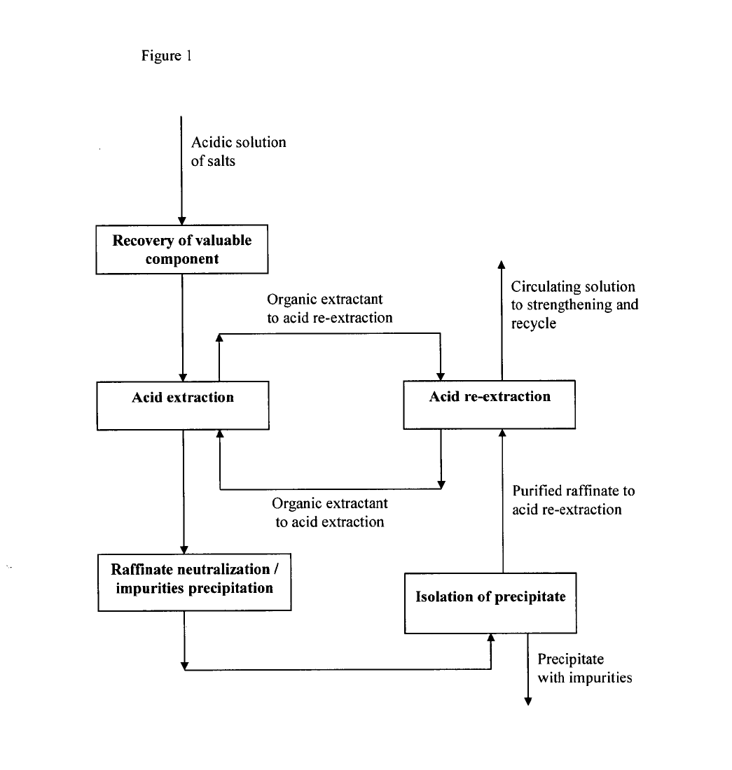

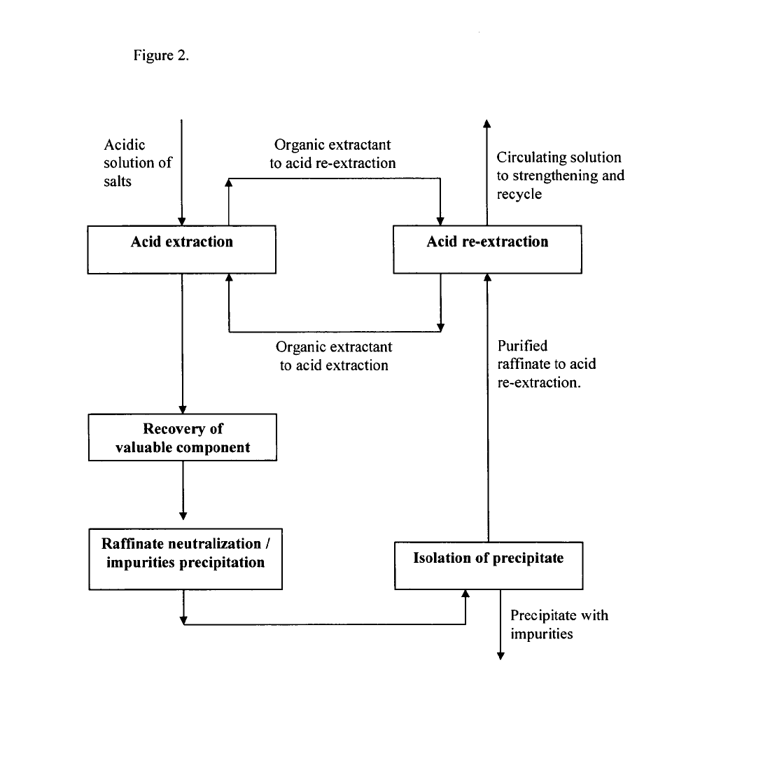

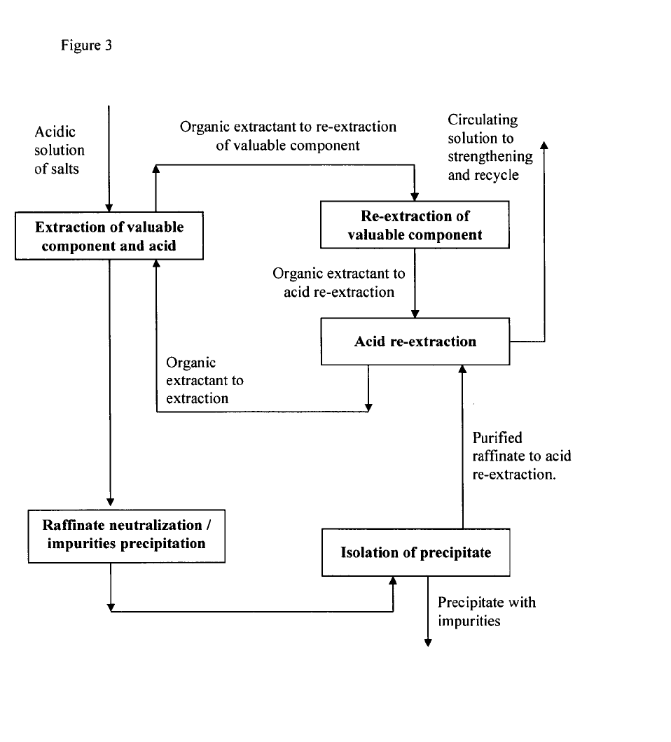

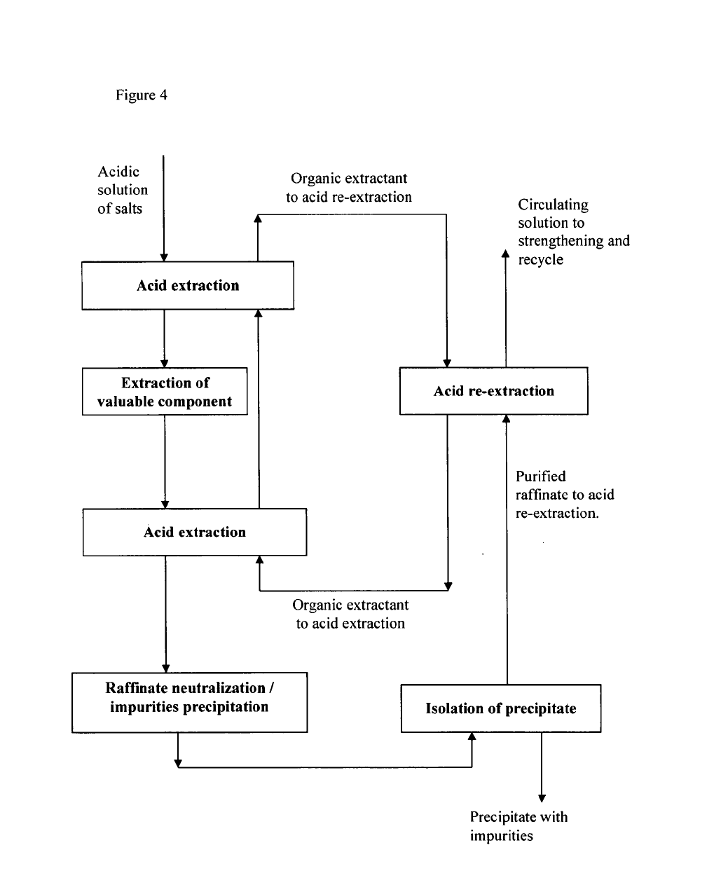

Priority of processes for recovery of valuable components (recovered components, except for phosphorus and fluorine) and the acid extraction may be arbitrary. According to the present invention, the acid extraction may be carried out: a) after the recovery of valuable components, and b) prior to removing valuable components c) simultaneously with the extraction of valuable components provided that an organic extractant suitable for extraction of both acid and a valuable component is used, d) before and after recovery of valuable components with the withdrawal of an aqueous solution from the acid extraction process and the extraction of valuable components, and returning the aqueous solution, a raffinate, into the acid extraction process. FIGS. 1-4 illustrate these aspects of the present invention.

The said valuable component can be, for example, REM compounds obtained during phosphogypsum processing.

The present invention is explained in more detail below using Figures and exemplary embodiments, serving solely for illustrative purposes and not intended to limit the scope of the present invention defined by the appended claims.

### Example 1

100 volume parts of a solution containing 250 g/L Ca(NO₃)₂, 60 g/L HNO₃, 2 g/L of rare-earth metal (REM) oxides Ln₂O₃, 6 g/L H₃PO₄, 1.5 g/L H₂SiF₆, were 4 times consequently contacted with 50 volume parts of undiluted tributyl phosphate (TBP) containing 125 g/L HNO₃. After the 4th contact, the raffinate contained 250 g/L Ca(NO₃)₂, 58 g/L HNO₃, 0.08 g/L Ln₂O₃, 6 g/L H₃PO₄, 1.5 g/L H₂SiF₆.

The obtained raffinate was directed to a glass column filled with 10 volume parts of methyl tert-butyl ether (MTBE) (the H/D ratio=40) with a flow rate of 10 parts/hour. The organic extractant MTBE was directed towards the aqueous solution with a rate of 7.5 parts/hour. The outgoing raffinate contained 250 g/L Ca(NO₃)₂, 6 g/L HNO₃, 6 g/L H₃PO₄, 1.5 g/L H₂SiF₆. The outgoing MTBE contained 70 g/L HNO₃.

Raffinate obtained after extraction of nitric acid was neutralized with lime to reach pH=6.0. Precipitate containing 35% CaHPO₄, 10% CaF₂, 2.5% SiO₂ was obtained. The neutralized solution contained 260 g/L Ca(NO₃)₂, 0.1 g/L H₃PO₄, <0.1 g/L of fluorides.

The neutralized solution was directed to a glass column filled with 10 volume parts of extract of nitric acid in MTBE (the H/D ratio=40) with a flow rate of 10 parts/hour. MTBE containing 70 g/l HNO₃ was directed towards the aqueous solution with a rate of 7.5 parts/hour. The outgoing raffinate contained 250 g/L Ca(NO₃)₂, 6 g/L HNO₃, 6 g/L H₃PO₄, 1.5 g/L H₂SiF₆. The outgoing organic extractant contained 8 g/L HNO₃. The outgoing solution contained 260 g/L Ca(NO₃)₂, 52 g/L HNO₃.

Thus, the recovery of valuable components (REM) from the salt solution was carried out, nitric acid was selectively extracted into the organic extractant, the solution was purified from phosphorus and fluorine impurities, then the organic extractant was regenerated, and the nitric acid was returned to the salt solution. Acid loss was 13.5%.

### Example 2

100 volume parts of a solution containing 160 g/L CaCl₂, 90 g/L HCl, 3 g/L of rare-earth metal (REM) oxides Ln₂O₃, 5 g/L H₃PO₄, 2.5 g/L H₂SiF₆, were 5 times consequently contacted with 100 volume parts of 50% organic solution of di-(2-ethylhexyl)phosphoric acid (DEHPA) in de-aromatized kerosene containing 70 g/L HCl. After the 5th contact, the raffinate contained 160 g/L CaCl₂, 91 g/L HCl, 0.06 g/L Ln₂O₃, 3 g/L H₃PO₄, 2.5 g/L H₂SiF₆.

The obtained raffinate was directed to a glass column filled with 10 volume parts of 3-methylbutan-2-one (methyl isopropyl ketone, MIPK) (the H/D ratio=40) with a flow rate of 10 parts/hour. The organic extractant MIPK was directed towards the aqueous solution with a rate of 50 parts/hour. The outgoing raffinate contained 160 g/L CaCl₂, 14 g/L HCl, 5 g/L H₃PO₄, 2.5 g/L H₂SiF₆. The outgoing MIPK contained 10 g/L HCL.

Raffinate obtained after extraction of hydrochloric acid was neutralized with lime to reach pH=6.0. Precipitate containing 40% CaHPO₄, 17% CaF₂, 4.5% SiO₂ was obtained. The neutralized solution contained 172 g/L CaCl₂, <0.1 g/L H₃PO₄, <0.1 g/L of fluorides.

The neutralized solution was directed to a glass column filled with 10 volume parts of extract of hydrochloric acid in MIPK (the H/D ratio=40) with a flow rate of 10 parts/hour. MIPK containing 10 g/l HCl was directed towards the aqueous solution with a rate of 50 parts/hour. Outgoing raffinate contained 250 g/L Ca(NO₃)₂, 6 g/L HNO₃, 6 g/L H₃PO₄, 1.5 g/L H₂SiF₆. The outgoing organic extractant contained 0.3 g/L HCl. The outgoing solution contained 172 g/L CaCl₂, 71 g/L HCl.

Thus, the recovery of valuable components (REM) from the salt solution was carried out, hydrochloric acid was selectively extracted into the organic extractant, the solution was purified from phosphorus and fluorine impurities, then the organic extractant was regenerated, and the hydrochloric acid was returned to the salt solution. Acid loss was 21.1%.

### Example 3

100 volume parts of a solution containing 250 g/L Ca(NO₃)₂, 60 g/L HNO₃, 2 g/L of rare-earth metal (REM) oxides Ln₂O₃, 6 g/L H₃PO₄, 1.5 g/L H₂SiF₆, 1.2 g/L KNO₃ were directed to a glass column filled with 10 volume parts of 4-methylpentan-2-one (methyl isobutyl ketone, MIBK) (the H/D ratio=40) with a flow rate of 10 parts/hour. The organic extractant MIBK was directed towards the aqueous solution with a rate of 10 parts/hour. Outgoing raffinate contained 250 g/L Ca(NO₃)₂, 2 g/L HNO₃, 2 g/L Ln₂O₃, 6 g/L H₃PO₄, 1.5 g/L H₂SiF₆, 1.2 g/L KNO₃. Outgoing MIBK contained 61 g/L HNO₃.

The obtained raffinate was twice consequently contacted with 50 volume parts of 20% solution of trialkyl phosphine oxide (TRPO) in de-aromatized kerosene. After the second contact, the raffinate contained 250 g/L Ca(NO₃)₂, 2 g/L HNO₃, 0.01 g/L Ln₂O₃, 6 g/L H₃PO₄, 1.5 g/L H₂SiF₆, 1.2 g/L KNO₃.

Raffinate obtained after extraction of REM was treated with 1 volume part of 40% H₂SiF₆, then the obtained raffinate was neutralized with lime to reach pH=6.0. Precipitate containing 33% CaHPO₄, 15% CaF₂, 5.5% SiO₂, 12% K₂SiF₆ was obtained. The neutralized solution contained 260 g/L Ca(NO₃)₂, 0.1 g/L H₃PO₄, <0.1 g/L of fluorides, 0.75 g/L KNO₃.

The neutralized solution was directed to a glass column filled with 10 volume parts of extract of nitric acid in MIBK (the H/D ratio=40) with a flow rate of 10 parts/hour. The organic extractant MIBK containing 61 g/L HNO₃ was directed towards the aqueous solution with a rate of 10 parts/hour. The outgoing organic extractant contained 3.5 g/L HNO₃. The outgoing solution contained 260 g/L Ca(NO₃)₂, 54 g/L HNO₃.

Thus, nitric acid was selectively extracted into the organic extractant, the recovery of valuable components (REM) from the subacid solution of salts was carried out, the solution was purified from phosphorus, fluorine and potassium impurities, then the organic extractant was regenerated, and the nitric acid was returned to the salt solution. Acid loss was 10%.

### Example 4

100 volume parts of a solution containing 250 g/L Ca(NO₃)₂, 60 g/L HNO₃, 2 g/L of rare-earth metal (REM) oxides Ln₂O₃, 6 g/L H₃PO₄, 1.5 g/L H₂SiF₆ were directed to a glass column filled with 10 volume parts of 20% solution of TRPO in MIBK (the H/D ratio=40) with a flow rate of 10 parts/hour. The organic extractant, 20% solution of TRPO in MIBK, was directed towards the aqueous solution with a rate of 12 parts/hour. The outgoing raffinate contained 250 g/L Ca(NO₃)₂, 9 g/L HNO₃, 0.22 g/L Ln₂O₃, 6 g/L H₃PO₄, 1.5 g/L H₂SiF₆. the outgoing extractant contained 82 g/L HNO₃ and REM.

Raffinate obtained after extraction was neutralized with lime to reach pH=6.0. Precipitate containing 47% CaHPO₄, 14% CaF₂, 3% SiO₂ was obtained. The neutralized solution contained 260 g/L Ca(NO₃)₂, 0.1 g/L H₃PO₄, <0.1 g/L of fluorides.

The organic extractant was 3 times consequently treated with 50 volume parts of nitric acid at concentration 360 g/L to recover REM therefrom. After the REM extraction, the organic phase contained 104 g/L HNO₃.

The neutralized solution was directed to a glass column filled with 10 volume parts of extract of nitric acid in the organic extractant (the H/D ratio=40) with a flow rate of 10 parts/hour. The 20% solution of TRPO in MIBK containing 104 g/L HNO₃ was directed towards the aqueous solution with a rate of 10 parts/hour. The outgoing organic extractant contained 16 g/L HNO₃. The outgoing solution contained 260 g/L Ca(NO₃)₂, 82 g/L HNO₃.

Thus, the recovery of valuable components (REM) from the salt solution was carried out simultaneously with nitric acid extraction into the organic extractant, the solution was purified from phosphorus and fluorine impurities, then the organic extractant was regenerated, and the nitric acid was returned to the salt solution.

While the present invention is described in detail above, one skilled in the art will recognize that modifications and equivalent substitutions can be made, and such modifications and substitutions are within the scope of the present invention defined by the appended claims.

1. A method for purification of acidic solutions of salts from phosphorus, fluorine and alkali metals impurities, the method comprising:
precipitation of calcium phosphates and fluorides and silicofluorides of alkali metals;
wherein before the precipitation of calcium phosphates and fluorides and silicofluorides of alkali metals, acid is selectively extracted into an organic extractant, while phosphorus, fluorine and alkali metals remain in raffinate; and
wherein after the precipitation of calcium phosphates and fluorides and silicofluorides of alkali metals the acid is re-extracted from the extractant into an aqueous solution.

2. The method of claim 1, wherein the alkali metal is selected from a group comprising sodium and potassium.

3. The method of claim 1, wherein the acid is selected from a group comprising nitric acid, hydrochloric acid, hydrobromic acid, hydroiodic acid, and perchloric acid.

4. The method of claim 1, wherein after the acid extraction and before the precipitation of calcium phosphates and fluorides and silicofluorides of alkali metals from aqueous solution, other valuable components presented in the aqueous solution other than phosphorus and fluorine are recovered therefrom.

5. The method of claim 4, wherein the other valuable component are rare-earth metals.

6. The method of claim 1, wherein the recovery of valuable components except phosphorus and fluorine from the solution is performed before the acid extraction.

7. The method of claim 1, wherein the recovery of other valuable components except phosphorus and fluorine from the solution is performed simultaneously with the acid extraction using an extractant capable of recovering the acid and the other valuable components simultaneously.

8. The method of claim 1, wherein the recovery of valuable components except phosphorus and fluorine is performed during the intermediate stage of the acid extraction by directing the acidic solution of salts to the acid extraction, withdrawing the aqueous solution containing the valuable component to the extraction of valuable components, and returning the resulted aqueous solution to the acid extraction process.

9. The method of claim 3, wherein ketones, mono- and polyethers, esters and amides of phosphoric acid or mixtures thereof are used for extraction of nitric, hydrochloric acids, hydrobromic and hydroiodic acids, and esters of phosphoric acid are used for extraction of perchloric acid.
